(19) United States
(12) Patent Application Publication
(10) Pub. No.: US 2002/0121169 A1
(43) Pub. Date: Sep. 5, 2002

(54) Retractable tape guide and cutter blade for tape dispenser

(76) Inventor: George J. LeMoine, Trumbull, CT (US)

Correspondence Address: John C. Hughs, PERMAN & GREEN, LLP, 425 Post Road, Fairfield, CT, 06430, US

(21) Appl. No.: 10/077,558

(22) Filed: Feb. 14, 2002

Related U.S. Application Data
(62) Division of application No. 09/611,690, filed on Jul. 7, 2000.
(60) Provisional application No. 60/142,846, filed on Jul. 8, 1999.
(60) Provisional application No. 60/142,847, filed on Jul. 8, 1999.

(51) Int. Cl. B26D 1/26; B26D 5/16; B26D 5/18; B26D 5/40; B26D 7/24

(52) U.S. Cl. 83/38; 225/60; 83/208; 83/223; 83/400; 83/649; 83/575; 83/587; 83/602; 83/604

(57) ABSTRACT

In a preferred embodiment, a sealing tape dispenser, includes a retracting tape guide which is mechanically linked to an access cover so as to be automatically retracted upon cover opening to allow larger tape rolls to be loaded and to enhance unobstructed access to the machine. In a second preferred embodiment, a sealing tape dispenser, includes a cutting blade lift and interlock mechanism as to assist in clearing tape jams by mechanically lifting the cutting blade to a raised position whereby unobstructed access is gained to the tape path and an interlock is disabled so as to prevent further tape dispenser operations while the cutting blade is in a raised position.

This application claims the benefit of U.S. Provisional Application No. 60/142,846, filed Jul. 7, 1999 entitled “Retracting Tape Guide Mechanism For Tape Dispensers”, and U.S. Provisional Application No. 60/142,847, filed Jul. 7, 1999, entitled “Blade Lifting Mechanism For Tape Dispensers.”

### FIELD OF THE INVENTION

The present invention relates to rolled material dispensers generally and, more particularly, but not by way of limitation, to a sealing tape dispenser and method of use having a novel blade lifting mechanism and a novel retracting tape guide mechanism for such dispensers.

### BACKGROUND ART

Mechanical and electronically controlled sealing tape dispensers are widely used for measuring a selected length of tape, cutting the tape, and also moistening the tape when required. The type of tape used with such machines can be paper, cloth, plastic, reinforced, or combinations of these, for example. Previously known tape dispensers have certain limitations. For one, tape dispensers usually dispense tape from a roll. The diameter of the roll may vary according to the length of tape contained in the roll. Of course it is usually more convenient for an operator to use a larger roll as this reduces the loss productivity due to loss time for removing an expended roll and reloading the tape dispenser with a fresh roll. Tape machines prior to this invention could only accept small rolls of tape due to fixed position idler rollers placed in the tape dispenser at various locations. Such a limitation causes the operator to use smaller tape rolls or engage in disassembly of the machine to remove the fixed position idler rolls.

A prior art tape dispenser as described in PCT/US00/01294 filed on Jan. 19, 2000, entitled “Electronically Controlled Sealing Tape Dispenser And Method”, and having a priority date of Jan. 19, 1999 from a US Provisional Application entitled “Electronically Controlled Sealing Tape Dispenser”, U.S. Provisional Application No. 60/116,275, is hereby fully incorporated by reference.

FIG. 1 illustrates a prior art electronically controlled tape dispenser of the type in which the present invention may be employed, the tape dispenser being generally indicated by the reference numeral 20.

Tape dispenser 20 includes a housing 30 having an external keypad 32 that includes a plurality of push buttons, as at 34. Push buttons 34 are used to select tape length to be dispensed from tape dispenser 20 and to perform other functions, as is described more fully below. Tape dispenser 20 further includes a water supply bottle 40, a water heater control 42, a slot 44 through which the tape (not shown) is dispensed, and a water applicator 46 for use when the tape is to be moistened. Electronic control circuitry is disposed within portion 50 of housing 30. The elements of tape dispenser 20 described above are common both to conventional tape dispensers and to a tape dispenser in which the present invention may be employed.

FIG. 2 illustrates a prior art control system, the control system being indicated generally by the reference numeral 100. Control system 100 includes a tape dispensing/cutting mechanism 102 which includes a drive motor 104, discussed above, and a solenoid 106 that operates a blade to cut the tape. Control system 100 also includes a tape machine controller board 120 that has a microcontroller 122 with memories 124 and 126. Microcontroller 122 is connected to tape dispensing/cutting mechanism 102 through motor control 130 and solenoid control 132. Microcontroller 122 is also connected to an optical tape sensor 140 through a tape sensor interface 142, the optical tape sensor being provided to sense the presence or absence of tape near its exit from the tape machine. Microcontroller 122 is further connected to tape length encoder 80′/82′ (FIG. 3) through a length encoder interface 150, to keyboard, or keypad, 32 through a keyboard interface 152, and to a foot switch interface 154 that permits the tape machine to dispense tape when a foot switch (not shown) is depressed. A power supply 156 provides electrical power to the various components of control system 100.

FIG. 3 illustrates control system 100 operatively connected to a remote host computer, or controller, 200. Host computer may actually provide control inputs for one or more of the functions of tape dispenser 20 and/or it may simply provide bookkeeping functions, such as tracking accumulated lengths of tape dispensed, the numbers of pieces of tape dispensed, the rate of use of the tape dispenser or other items relating to the use of the tape dispenser. This information can be used, for example, to determine when the roll of tape in tape dispenser 20 requires replacement.

It will be understood that RS-232 driver/receiver transmission protocol may be used when host computer 200 is operatively connected only to tape dispenser 20 and that RS-485 driver/receiver transmission protocol may be used when more than one tape dispenser is operatively connected to the host computer. Transmission may be over hard wired lines or it may be via RF communication means.

To clear a tape jam on prior art models of tape dispensers, the water bottle and tank have to be removed. Then the blade mechanism is lifted by hand from below against the force of the return spring. This exposes the fingers to mechanical hazards and possible injury should the tape dispenser accidentally operate during jam clearance. For safety reasons, access to the blade mechanism has been denied with the installation of a fixed steel baffle plate, thus requiring another means of lifting the blade mechanism.

A limitation of these prior art tape dispensers is that they cannot accept large rolls of tape, for example a 1000′ roll, without disassembly.

Another limitation is that, although tape dispensers typically have means to cut the tape, such cutters do not have a safe or easy method to clear tape jams.

All of these limitations require additional time and effort on the part of the operator, thus creating unnecessary cost and/or waste.

Accordingly, it is a principal object of the invention to provide means and method to allow larger size tape rolls to be easily loaded into the tape dispenser.

It is a further object of the invention to provide means and method to safely and easily gain access to the blade cutter to clear tape jams.

It is another object of the invention to provide such means and method that are economically employed.

Other objects of the present invention, as well as particular features, elements, and advantages thereof, will be elucidated in, or be apparent from, the following description and the accompanying drawing figures.

### SUMMARY OF THE INVENTION

The present invention achieves the above objects, among others, by providing, in a preferred embodiment, a sealing tape dispenser, having a housing including a top multi-part cover with a retractable guide roller assembly which retracts with the rear cover as the rear cover is opened to allow large tape rolls to be easily loaded into the tape machine. A second preferred embodiment achieves the above objects, among others, by providing a safety cutting blade lever which through manual rotation activates a cam to raise the cutting blade to allow an operator safe access to the cutting area for clearing tape jams. The safety lever also provides a mechanical interlock such that the machine may not be operated until the lever is rotated back to an operable position. Thus, the present invention is a mechanism which provides a retractable guide roller for a tape dispenser, articulated with the rear cover of the dispenser to allow for access and clearance for a 1000-foot roll of tape, while providing an operating position that correctly controls the tape during dispensing, and further by providing a mechanism for lifting the blade of a tape dispenser to allow for the safe clearance of tape jams without having to remove any components from the tape dispenser or expose the operator or the tape dispenser to possible injury.

### BRIEF DESCRIPTION OF THE DRAWINGS

Understanding of the present invention and the various aspects thereof will be facilitated by reference to the accompanying drawing figures, submitted for purposes of illustration only and not intended to define the scope of the invention, on which:

FIG. 1 is an isometric view of a prior art tape dispenser;

FIG. 2 is a block diagram of a prior art control system;

FIG. 3 is a block diagram of the control system of FIG. 2 operatively connected to a remote host computer;

FIG. 4 is a fragmentary perspective view of a first embodiment of a tape dispenser having a retractable guide roller;

FIG. 5 is a fragmentary perspective view of a first embodiment of a tape dispenser having a retractable guide roller with the multi-part covers in a closed position;

FIG. 6A is a fragmentary perspective view of a first embodiment of a tape dispenser having a retractable guide roller with a top cover in an open position and a rear cover in a closed position;

FIG. 6B is a fragmentary perspective view of a first embodiment of a tape dispenser having a retractable guide roller with a top cover in an open position and a rear cover in a closed position;

FIG. 7 is a fragmentary side elevation view of a first embodiment of a tape dispenser having a retractable guide roller with a top cover in an open position and a rear cover in a closed position;

FIG. 8 is a fragmentary side elevation view of a first embodiment of a tape dispenser having a retractable guide roller with a top and rear covers in their open position;

FIG. 9 is a fragmentary perspective view of a first embodiment of a tape dispenser having a retractable guide roller with a top and rear covers in their open position and showing a roll of tape inserted and threaded through the tape dispenser;

FIG. 10 is a fragmentary perspective view of a first embodiment of a tape dispenser having a retractable guide roller with a top and rear covers in their open position and showing a roll of tape inserted and structural side members;

FIG. 11 is a fragmentary perspective view of a first embodiment of a tape dispenser having a retractable guide roller with a top cover in an open position and a rear cover in a closed position and showing a roll of tape inserted and structural side members;

FIG. 12 is a fragmentary side elevation view of a first embodiment of a tape dispenser having a retractable guide roller with a top and rear covers in their open position showing a roll of tape inserted and threaded through the tape dispenser;

FIG. 13 is a fragmentary side elevation view of a first embodiment of a tape dispenser having a retractable guide roller with a top cover in an open position and a rear cover in a closed position showing a roll of tape inserted and threaded through the tape dispenser;

FIG. 14 is a fragmentary perspective view of a second embodiment of a tape dispenser having a retractable cutting blade mechanism in an operable position;

FIG. 15 is a fragmentary perspective view of a second embodiment of a tape dispenser having a retractable cutting blade mechanism in an inoperable position;

FIG. 16 is a fragmentary perspective view of a second embodiment of a tape dispenser having a retractable cutting blade mechanism in an inoperable position and showing a roll of tape inserted and threaded through the tape dispenser;

FIG. 17 is a fragmentary perspective view of a second embodiment of a tape dispenser having a retractable cutting blade mechanism in an inoperable position and showing a roll of tape inserted and threaded through the tape dispenser;

FIG. 18 is a fragmentary side elevation view of a second embodiment of a tape dispenser having a retractable cutting blade mechanism in a operable position and showing a roll of tape inserted in the tape dispenser;

FIG. 19 is a fragmentary side elevation view of a second embodiment a tape dispenser having a retractable cutting blade mechanism in an inoperable position and showing a roll of tape inserted in the tape dispenser;

### DETAILED DESCRIPTION OF THE PREFERRED EMBODIMENTS

Reference should now be made to the drawing figures, on which similar or identical elements are given consistent identifying numerals throughout the various figures thereof, and on which parenthetical references to figure numbers direct the reader to the view(s) on which the element(s) being described is (are) best seen, although the element(s) may be seen also on other views.

First Preferred Embodiment

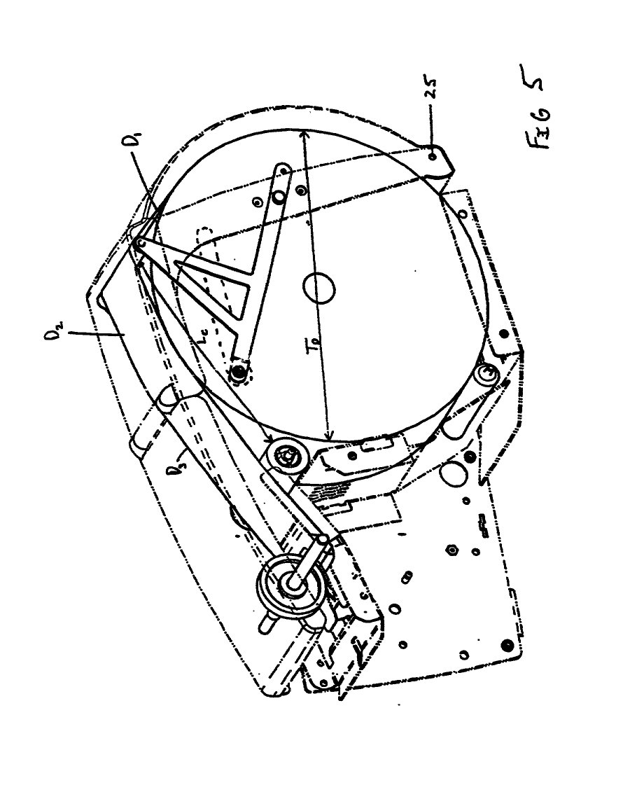

FIG. 4 illustrates a tape of the type in which the present invention may be employed, the tape dispenser being generally indicated by the reference numeral 20.

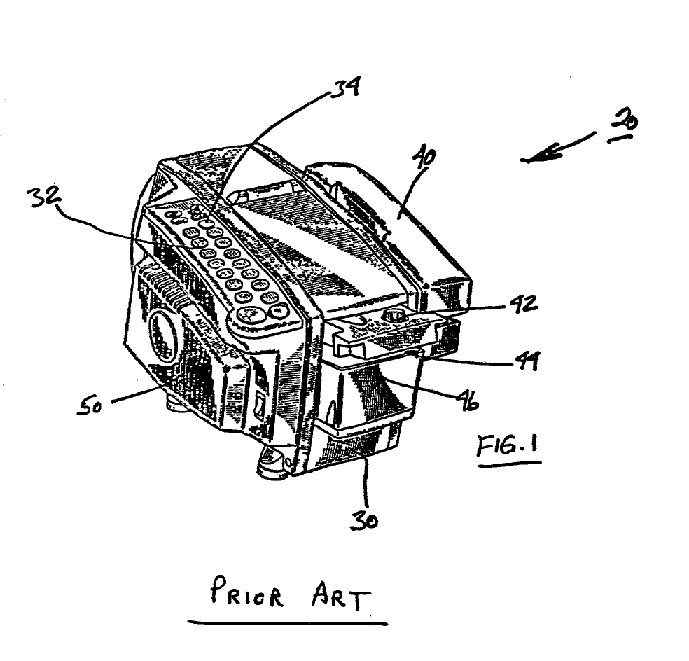

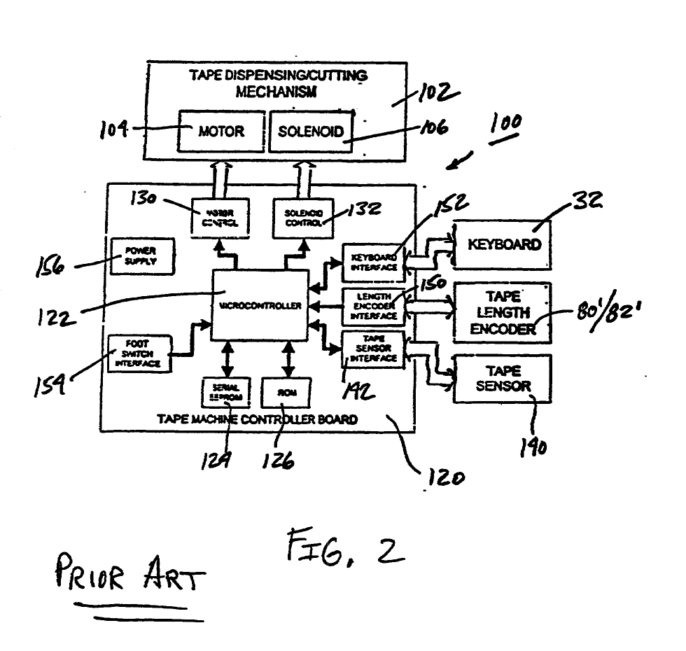

Tape dispenser 20 includes a housing (see FIG. 1) and a multi-part cover 22 having a rear portion 24 and a top portion 26. The multi-part cover 22 opens by pivoting about two hinges. The first hinge 28 allows the entire multi-part cover 22 to rotate to the rear of the tape dispenser 20. The second hinge 29 allows the top portion 26 to rotate relative to the rear portion 24 so that the top portion 26 folds onto the rear portion 24 as shown in FIG. 4. This combined movement of the top 26 and rear cover 24 portions relative to the tape dispenser 20 exposes the entire top internal workings of the tape dispenser 20.

In this view a fresh roll of tape 10 has been loaded into the machine and threaded for use as will be described in detail below. Typically a tape dispenser is sized to accommodate tape rolls of a maximum width and maximum circumference. These dimensions are usually dictated by the internal dimensions of the tape dispenser 20. In this FIG. 4, a tape roll 10 of maximum width and circumference is shown.

A fresh tape roll 10′ is loaded into the tape dispenser from the top of the machine 20 and comes to rest as shown by tape roll 10 along loading path L. The maximum diameter tape roll which can be loaded is determined by the clearance between retracting tape guide 2 and roller 4.

In this view the tape dispenser 20 is ready to dispense tape. The tape roll 10 has been threaded along tape path Pₙ (where n is 1-7). This path begins at the tape roll rear and travels upwards so as to pass over and in contact with idler roller. The tape path then continues forward passing over roller B and onto the dispensing tray 300. In the dispensing tray 300, a drive wheel 302 frictionally urges tape forward through an aperture in a cutting blade 200 and finally onto the exit tray 304.

A new and improved retracting tape guide 2 has been mounted to the tape dispenser 20 in a novel manner so as to allow the easy loading of large tape rolls. The retractable tape guide 2 is rotatably supported by a rod 5 where each end of the rod is fixed mounted into a pair of A-frame support arms 6. The horizontal portions of the A-frame extend beyond the A-legs to a short arm and a long arm. Each short arm 6 of the pair of A-frames 6 is slidably mounted into a essentially horizontal slot 7 cut into a respective pair of side frames 22 & 23.

The second arm 8 of the A-frame is rotatably mounted to the rear portion 24 of the multipart cover 22 at hinge 13.

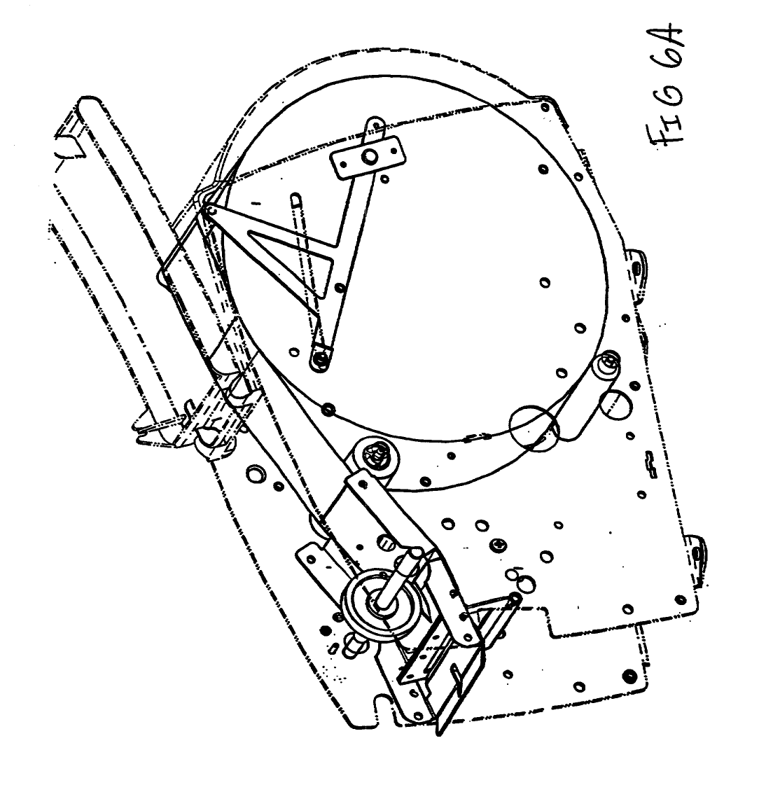

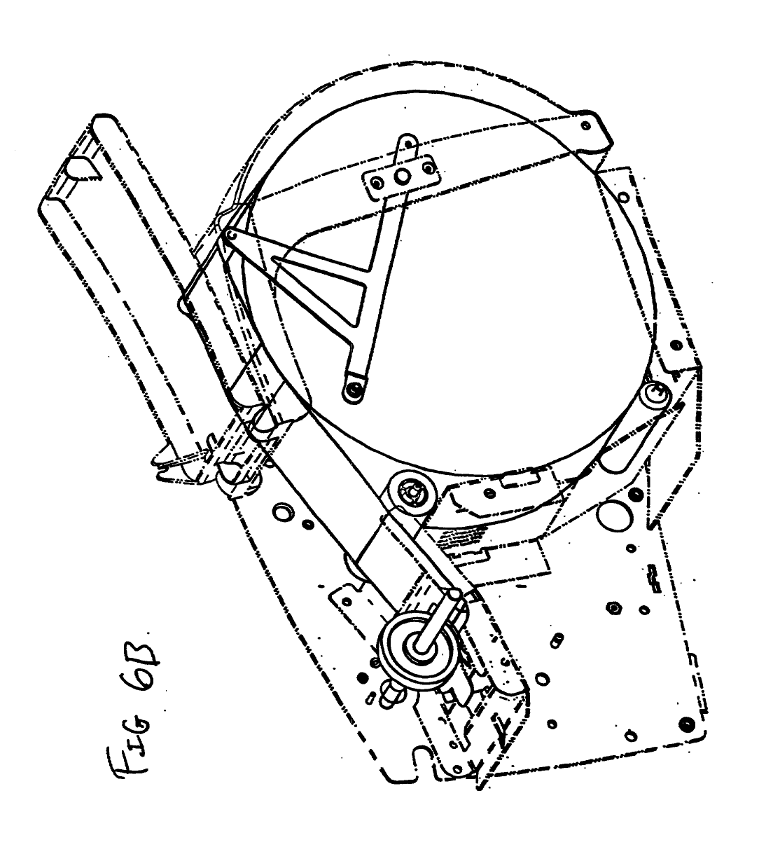

FIG. 5 shows the tape dispenser 20 with the multi-part cover 22 in a closed position. Rear cover 24 has rotated forward about hinge 25 and top cover 26 has rotated forward and downwards about hinge 29 to the fully closed position as shown. The covers 24,26 are also shown in a closed position in FIG. 1.

Retractable tape guide 2 has now moved forward as the A-frame pair was driven forward by their hinge points 13 and further restrained by slots 7. The retractable tape guide 2 is now located over the tape roll 10 so as to guide the tape along its dispensing tape path Dₙ. (where n=1-3). In this closed position, the retractable tape guide maintains the desired tape path D₁ through D₃. The retractable tape guide 2 assists in making sure tape is pulled in an upwards manner from the tape roll regardless of the tape roll circumference. It is well known that the tape roll diameter TD continually decreases as tape is dispensed from the roll. Maintaining an upward pull along tape path D1 from the tape roll 10 prevents the tape roll from climbing up and forward out of it's proper place as shown in FIG. 4.

As the rear cover 24 transitions from a closed position as shown in FIG. 5 to an open position as shown in FIG. 4, the rear cover 24, through the fixed hinge located at 13, pulls the A-frame leg 8 towards the rear of the tape dispenser 20. This causes the short leg 6 to follow while constrained by the horizontal slot 7. As the A-frame translates towards the rear of the tape dispenser 20 and rotates in a CW manner, the retractable guide roller 2 is caused to move from the closed position in FIG. 5 to the open position in FIG. 4.

In the open position as shown in FIG. 4, it can be seen that the ability for the tape dispenser to accept larger tape rolls without disassembly is clear as the distance between the retractable guide roller 2 and idler roller 4 has increased by approximately the length of the horizontal slot 7.

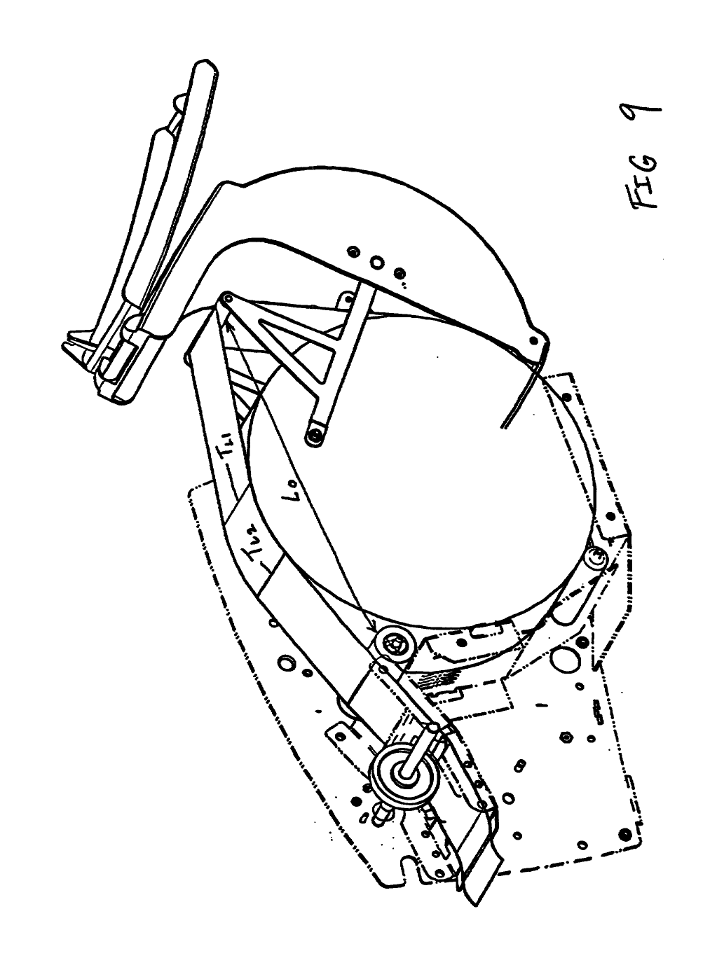

A spring 350 (FIG. 7) is attached to the end of the A-frame leg 8 to provide both a cover closing force and a cover stay open force depending upon the relative position of the rear cover to the spring attachment point.

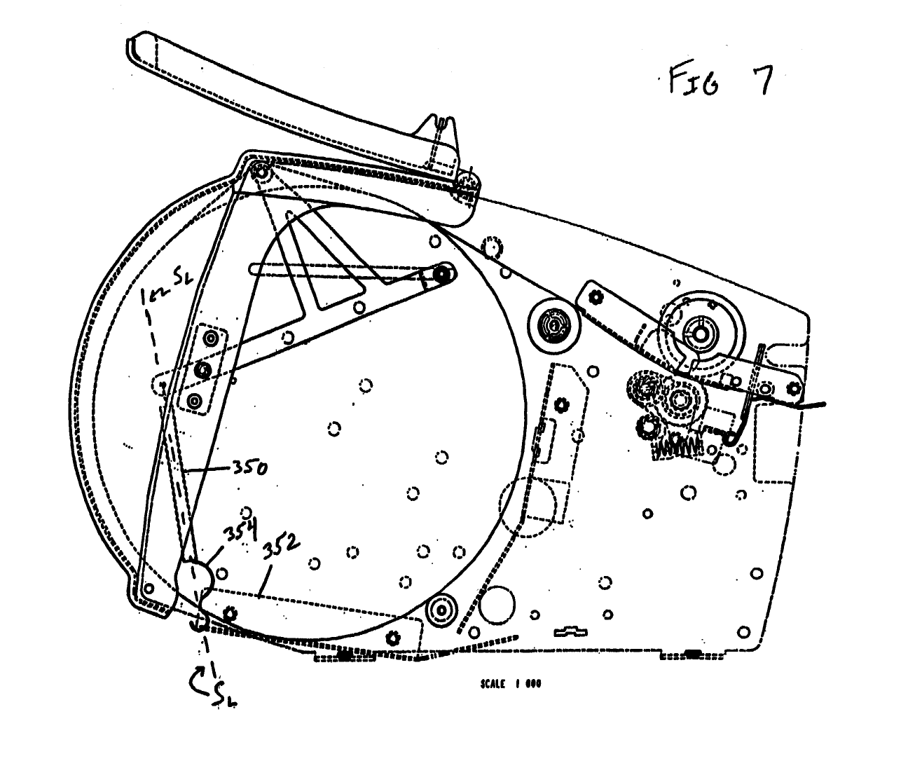

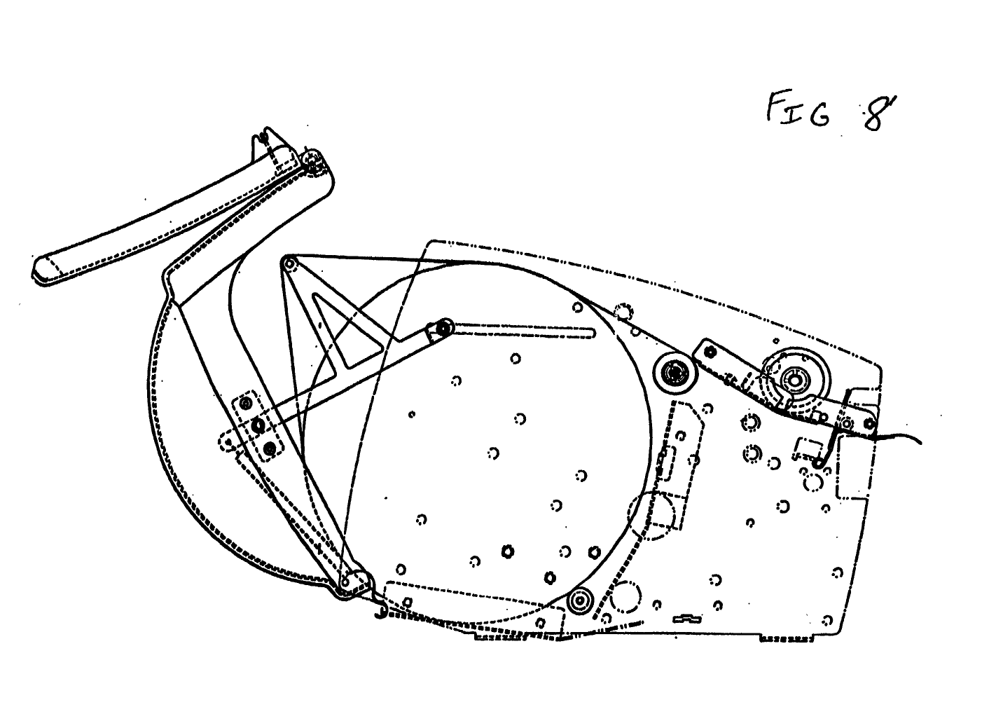

FIG. 6 shows the rear cover 24 closed and the top cover 26 open. The near side panel has been removed while the far side panel remains intact. With the top cover 26 in the open position as shown, the tape dispenser 20 remains inoperable as the top cover 26 disables a magnetic interlock (not shown) when the top cover 26 is raised.

FIG. 7 shows a left side elevation view of the tape dispenser 20. In this view a helical spring 350 attaches to one end of the A-frame long arm and to chassis base 352 by means of curved hook 354. These two attachment points define a spring line SL which is important for reasons discussed below. Due to the geometry of the rear cover hinge 28 relative to the spring line SL, the following occurs. When the hinge point 28 is to the left of the spring line SL, as shown in FIG. 7, the spring urges the rear cover 24, through its attachment to the A-frame long arm 8 to move towards its closed position as shown in FIG. 7, and assists the cover in remaining in that position.

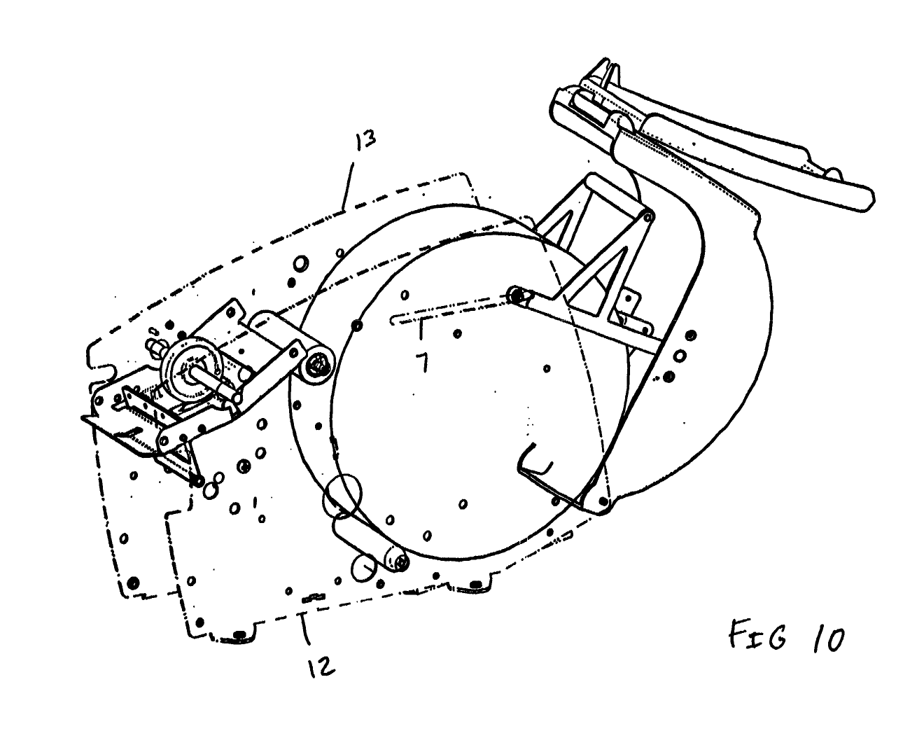

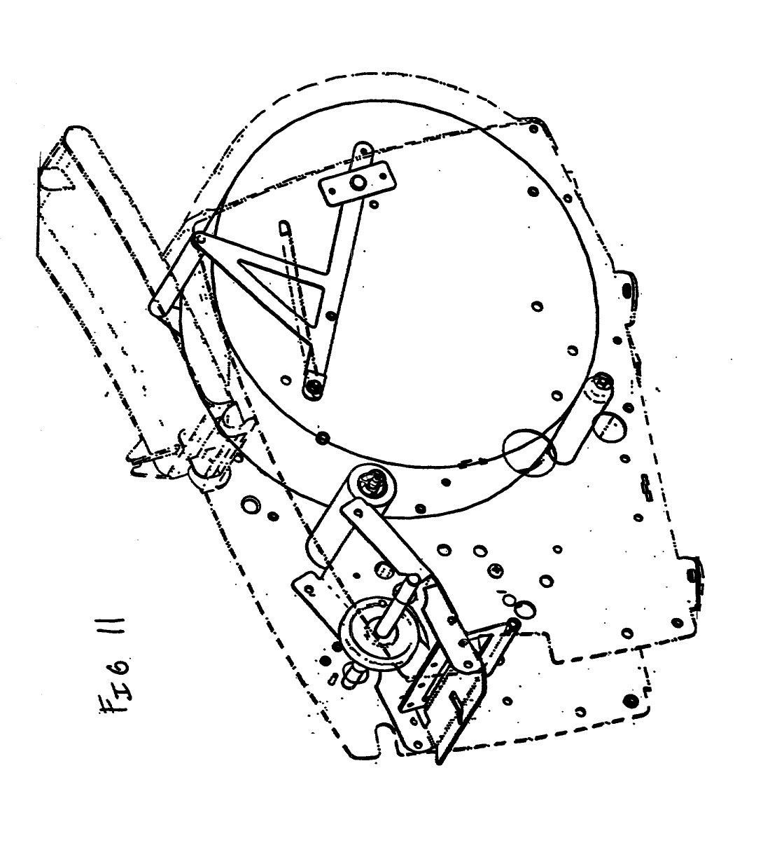

FIG. 8 shows the rear cover 24 in an open or almost fully open position. It can be seen, from a geometry point of view, that spring line SL is very close to intercepting hinge point 28. When spring line SL does in fact intersect hinge point 28, the spring forces transmitted to the rear cover become neutral with respect to causing any rotation of the rear cover about hinge point 28. When the rear cover 24 rotates even further in a counter clock wise manner, spring line SL will pass hinge point 28 so that the hinge point 28 now lies to the right of the spring line SL, again from geometrical point of view. In this fully open position, the spring 350 urges the cover 24 to remain in an open position. The curve hooked 354 is shaped so as to assist the spring in traveling to the left beyond the hinge point 28 without any mechanical interference.

It should be noted that with respect to the covers being in an open position, the mass of the rear cover, top cover, spring assembly, and A-frame assembly will present a rotational force on the rear cover 24 itself to stay open. Therefore the spring line SL, depending upon the mass of the covets and spring assembly itself; will not have to pass entirely to the left of the hinge point 28 to maintain the covers in an open position. In fact the spring line SL may remain to the right of the hinge point 28, and sufficient force from the above mentioned masses will keep the cover 24 open.

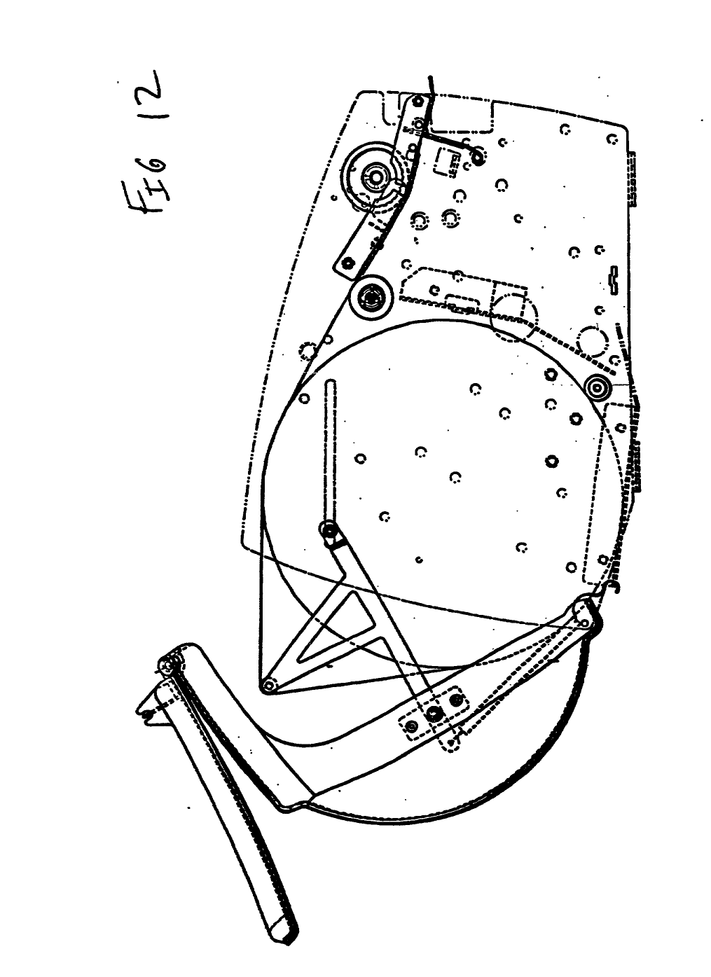

FIG. 9 shows the tape path after a fresh tape roll has been loaded into the tape dispenser 20. Tape tangent lines T_{L1} and T_{L2} are shown where the tape dispensing from a large roll makes contact with the roll itself until the roll has decreased in size due to use. It should be noted that this contact causes very little concern as both the dispensing tape and the tape roll which are in contact with each other are actually moving in the same direction with very little difference in absolute velocities.

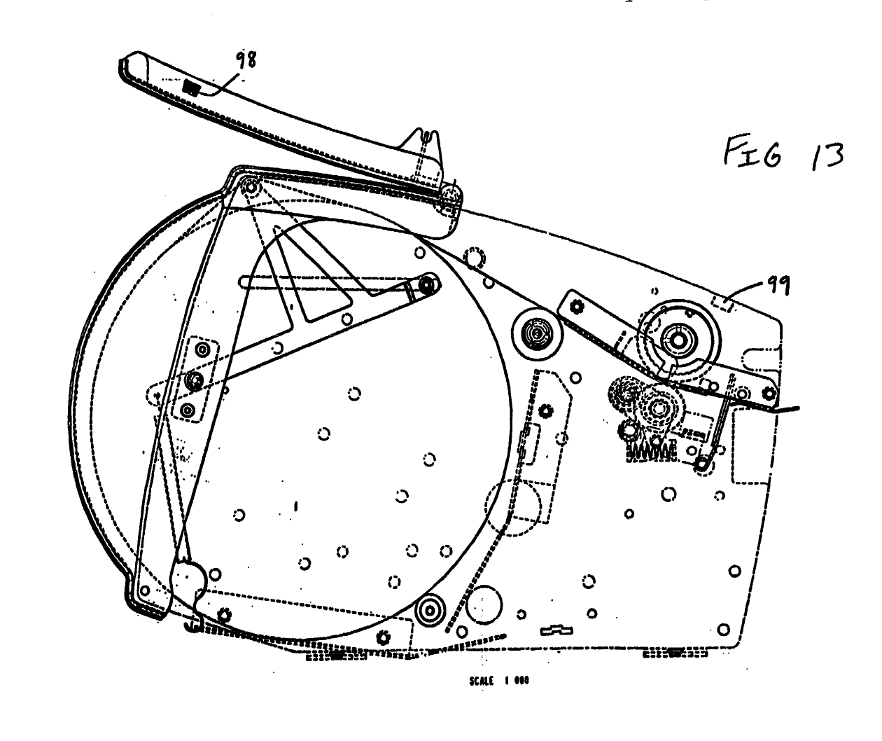

FIG. 10 shows both side frames, 12 & 13 into each of which are cut the slots 7, 8 (not shown) which guide the A-frame short arm 6 during its transition from an open position to a closed position.

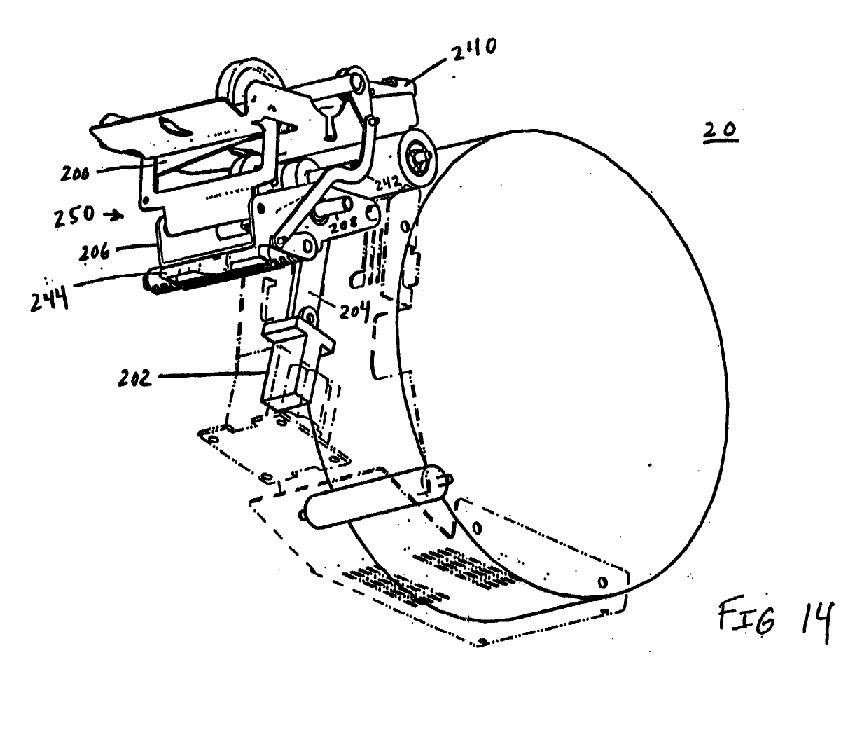

FIG. 11 shows both side panels 12,13 (in phantom) with the tape roll resting on lower idler roller.

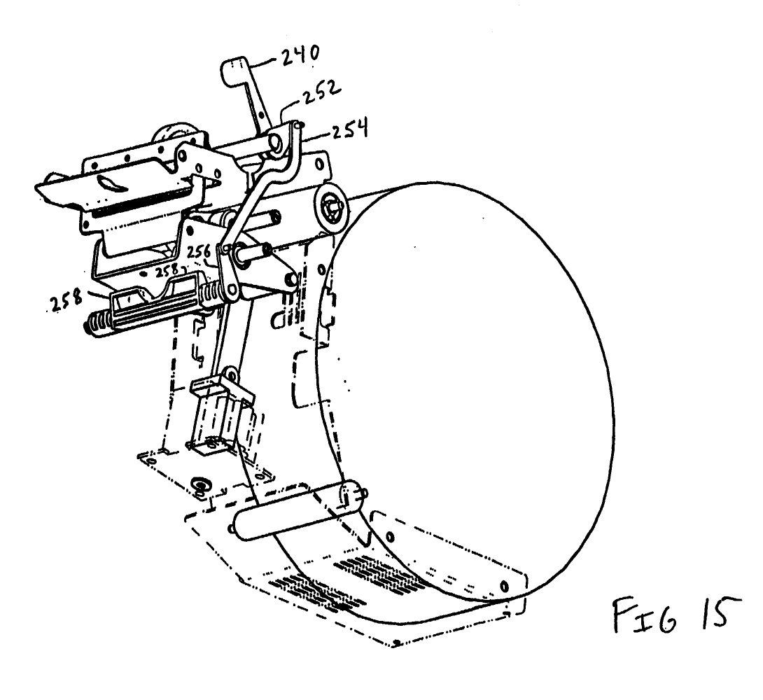

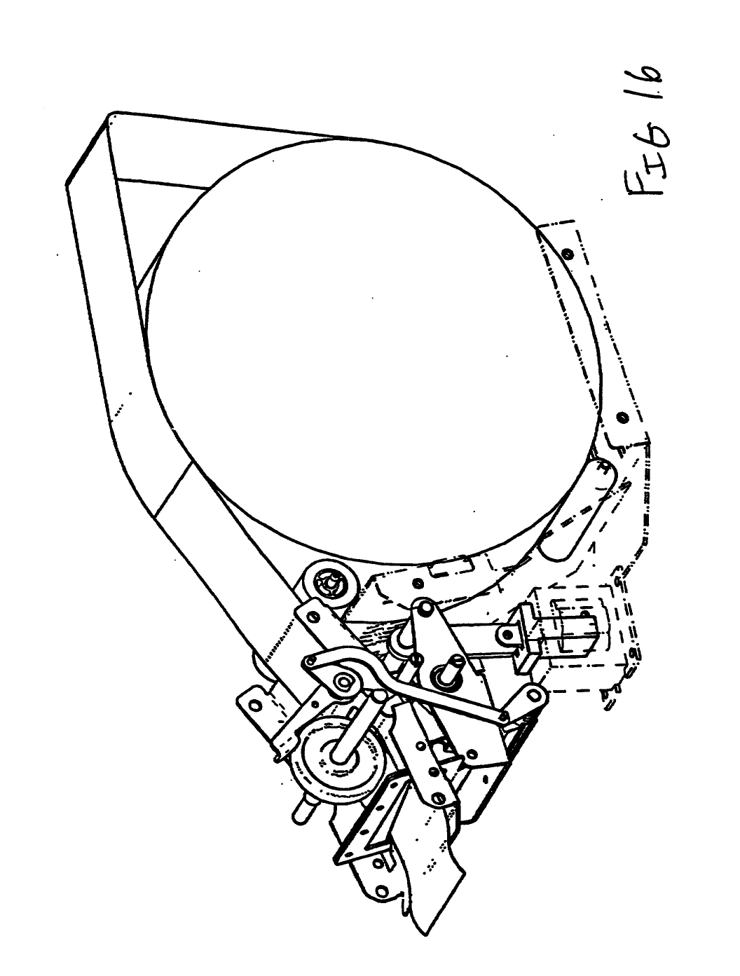

FIG. 12 shows the rear and top covers 24, 26 in their fully open positions with the retractable tape guide in a fully retracted position which maximizes the distance between the retractable tape guide 2 and the upper idler roller 4.

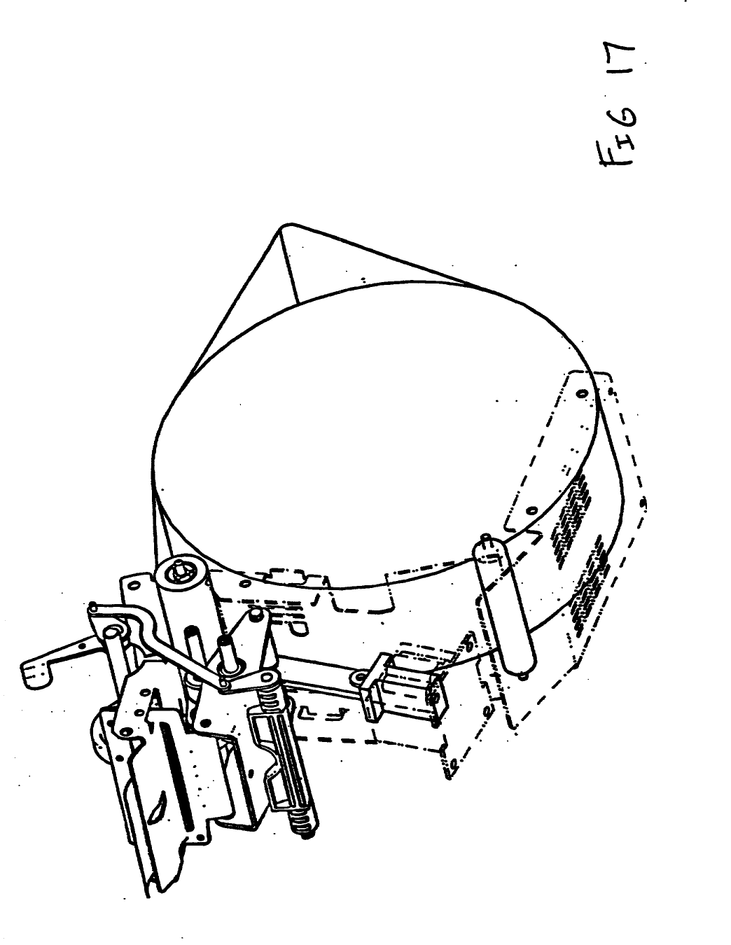

FIG. 13 shows the rear cover fully closed however with the top cover fully open. The tape has been threaded as shown by tape path D₁ through D₃. The machine remains inoperable however due to the magnetic interlock 98, 99 being in an open configuration.

positions with the retractable tape guide in a fully retracted position which maximizes the distance between the retractable tape guide and the upper idler roller.

### DETAILED DESCRIPTION OF THE PREFERRED EMBODIMENTS

Reference should now be made to the drawing figures, on which similar or identical elements are given consistent identifying numerals throughout the various figures thereof, and on which parenthetical references to figure numbers direct the reader to the view(s) on which the element(s) being described is (are) best seen, although the element(s) may be seen also on other views.

Referring to all figures together, there is illustrated a tape dispenser employing the present invention, the tape dispenser being generally indicated by the reference numeral 10.

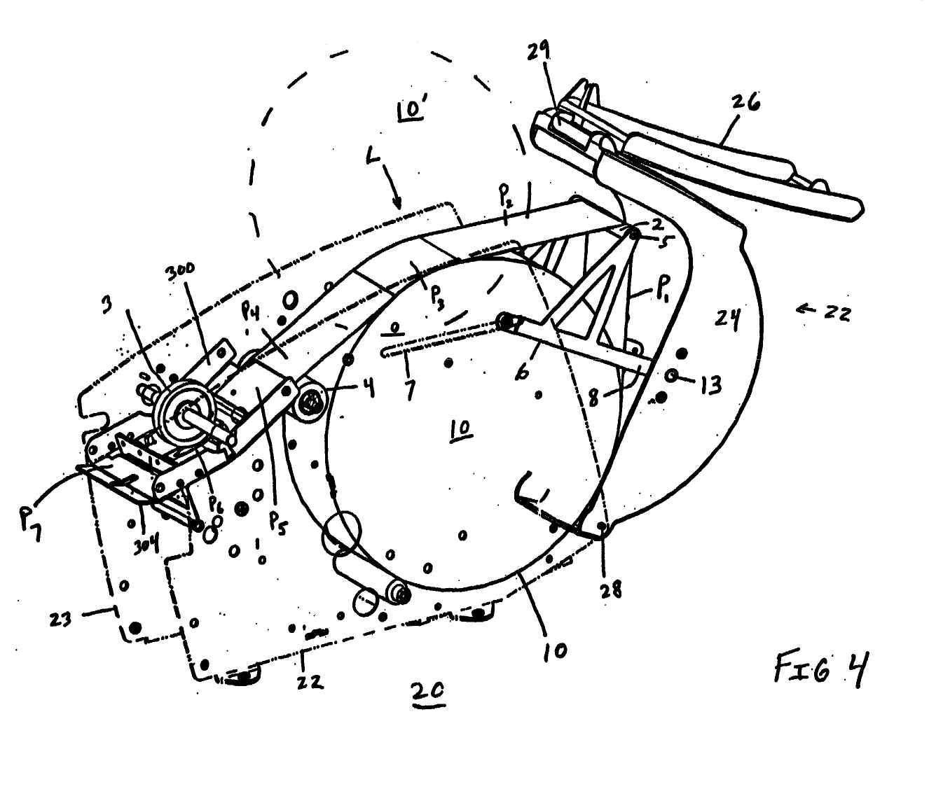

Tape dispenser 10 includes a housing having two side members 12 joined together by conventional means. An inverted L-shaped rear cover 20 is rotatingly attached to side members by hinges 22 (only one shown). The proximal ends of two roller support plates 30 are hingedly attached by two hinges 32 (only one shown) to the sides of rear cover 20 about in the middle of the front edges of the rear cover, while the proximal ends of the roller support plates ride in two horizontal slots 34 defined in side members 12. Roller support plates 30 support a lift roller 40 over which lift roller passes tape from roll of tape 42 (FIG. 3).

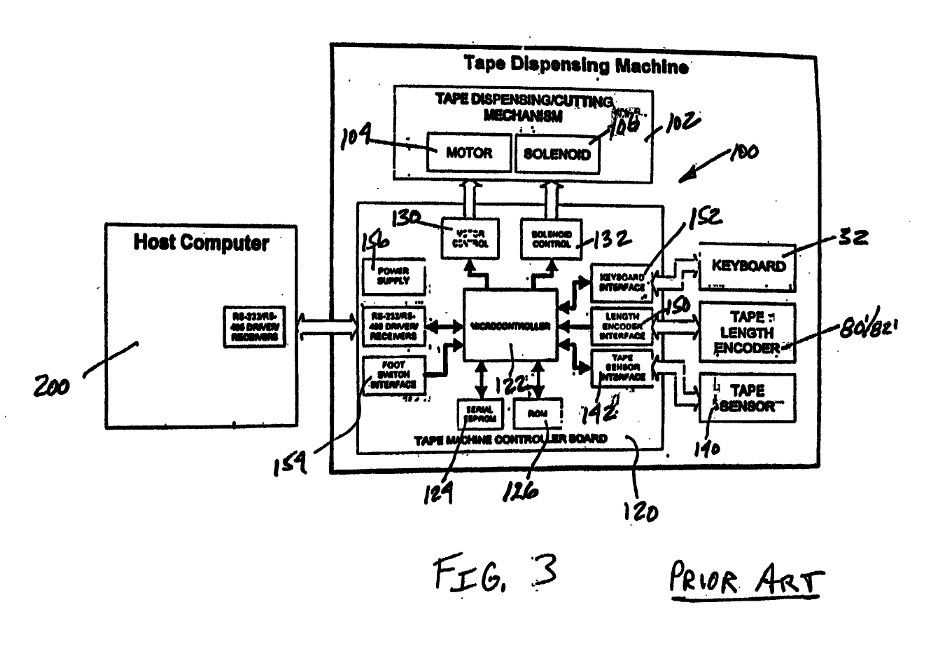

The geometry is arranged such that, in the closed cover position (FIG. 2), lift roller 40 causes the tape to somewhat lift the roll of tape 42 in a generally vertical direction during dispensing, thus reducing friction against the basket (not specifically shown) on which the roll of tape rests. When dispensing is finished, roll of tape 42 drops and is braked by the basket. In the cover open position (FIGS. 1 and 3), rear cover 20 pull, roller support plates 30 backwards along horizontal slots 34, carrying lift roller 40 back also away from roll of tape 42. This greatly facilitates “drop-in” loaning of roll of tape 42 from the preferred position which is above tape dispenser 10.

A spring 50 holds the rear cover assembly with the support plates closed in the operating position and holds it open in the loading position.

Second Preferred Embodiment

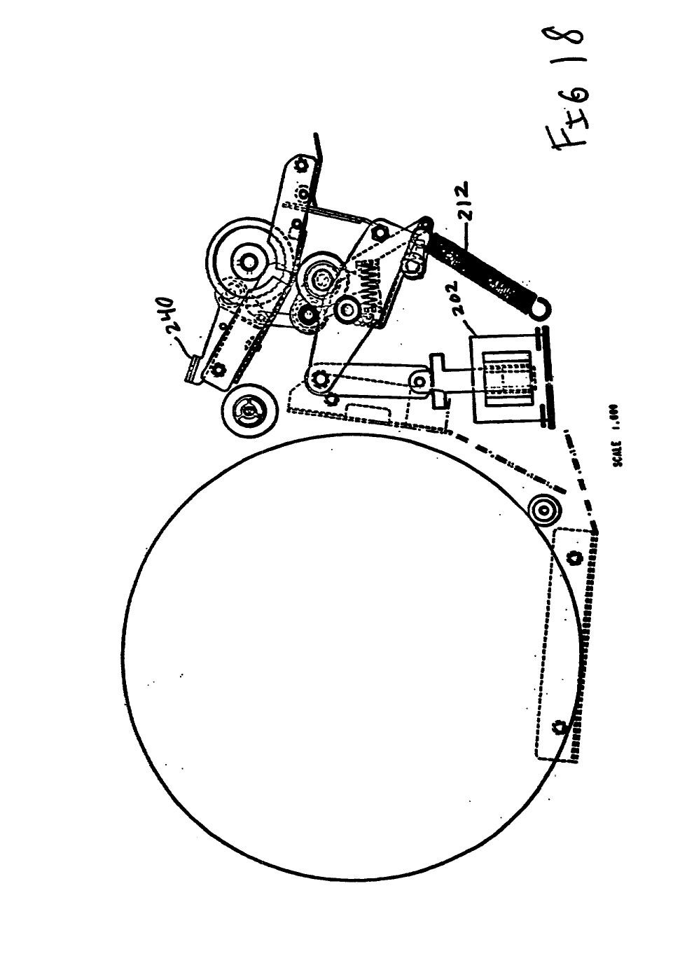

Referring to FIGS. 14-19 together, there is illustrated a tape dispenser employing the present invention, the tape dispenser being indicated generally by the reference numeral 20.

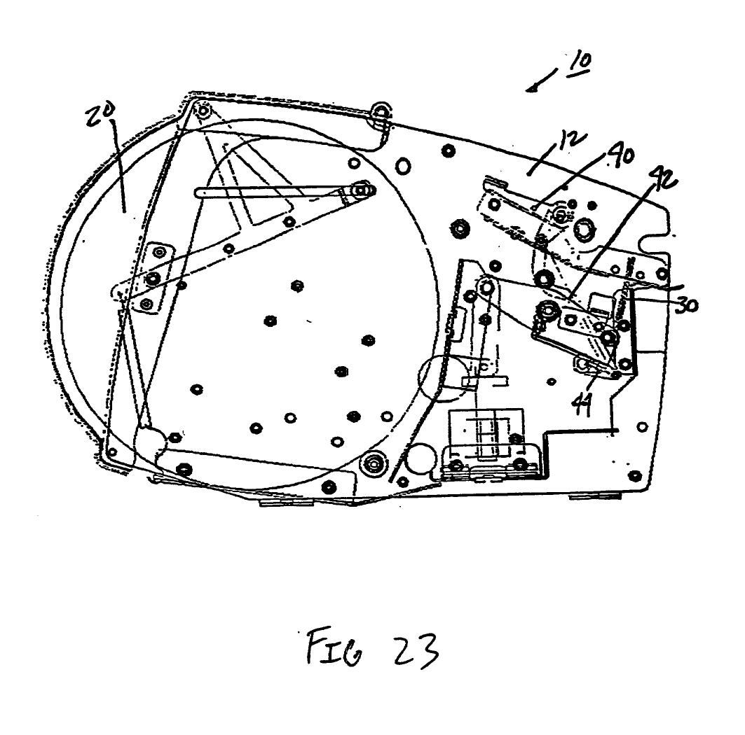

FIG. 14 shows a view illustrating the cutting blade lift mechanism. The cutting blade 200 is normally in the position shown, a down position. When an operator requests the machine to dispense tape, the cutting blade 200 is raised by a mechanical linkage activated by a solenoid 202. The solenoid 202 pulls down on a linkage arm 204 which causes the cutting blade actuator arm 206 to rotate about the arm shaft 208. When the actuator arm 206 rotates clockwise, the cutting blade frame 210 moves upward to raise the cutting blade 200 and provide a clear and unobstructed path for tape to flow out of the machine. Once the requested length of tape has been dispensed, the solenoid relaxes and a return spring 212 (FIG. 18) forcefully powers the cutting blade 200 in a downward path, severing the tape which has just been dispensed.

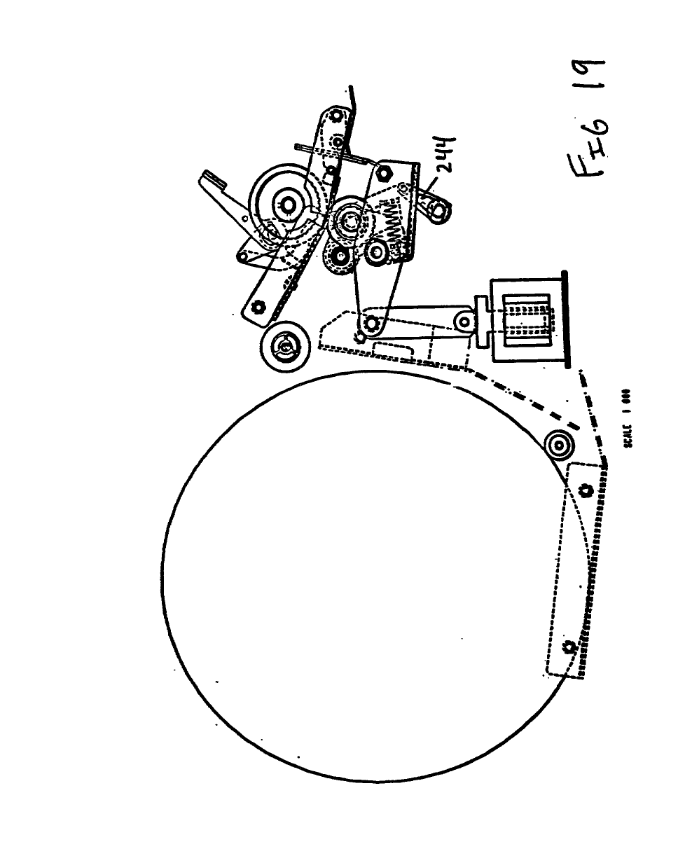

To clear a tape jam, the cutting blade 200 must be raised so as to gain access to the tape path near and around the cutting blade 200. A lever 240 rotatably disposed adjacent one of side members (see FIG. 20) is connected through a linkage assembly 242 to a cam 244 located under blade assembly 250. When lever 240 is in its nearly horizontal closed position as shown in FIG. 14, blade assembly 250 is in its normal cutting position. However, when lever 240 is moved to its nearly vertical open position (FIG. 15), blade assembly 250 is raised and held up for hands free access for jam clearing. With lever 240 in its open position, the top cover (not shown) of tape dispenser 20 is prevented from returning to its home or operating position, further increasing operator safety.

Tape dispenser 20 includes two side members 12 joined together in a conventional manner. Tape dispenser 20 includes therein a roll of tape 20. Although not shown on any of the figures, but in accordance with conventional construction of tape machines, tape from roll of tape 20 would be led through a blade assembly 250 at the front of tape dispenser 20 for dispensing in selected lengths by means of the blade assembly cutting the tape in the selected lengths.

Lever 240 is also used to adjust the idler wheel. Tooling holes in lever 240 and side member 12 position the blade for optimum height, while the wheel position is adjusted for optimum drive force. Again, service provider safety is considered, as hands are all located outside of the mechanism of tape dispenser 20. Both hands are free to provide service and the adjustment is made more consistently.

FIG. 15 shows the lever 240 raised into its upward position for raising the cutting blade 200. As the lever 240 rotated m a counter-clockwise manner, lever arm 252 rotated similarly raising the linkage arm 254. The upward movement of the linkage arm 254 caused cam arm 256 to rotate in a clock-wise direction. The cam arm 256 caused the cam 244 to similarly rotate and present the cam lobes 258 against the lower surface of the actuator arm 206. The actuator arm 206 thereby rotated in a clock-wise manner lifting the blade assembly 250 causing the cutting blade 200 to raise up. Thus the initial rotational movement of the lever 240 causes the cutting blade 200 to move to its upward position and provide a clear and obstructed access to the tape path near and around the cutting blade 200.

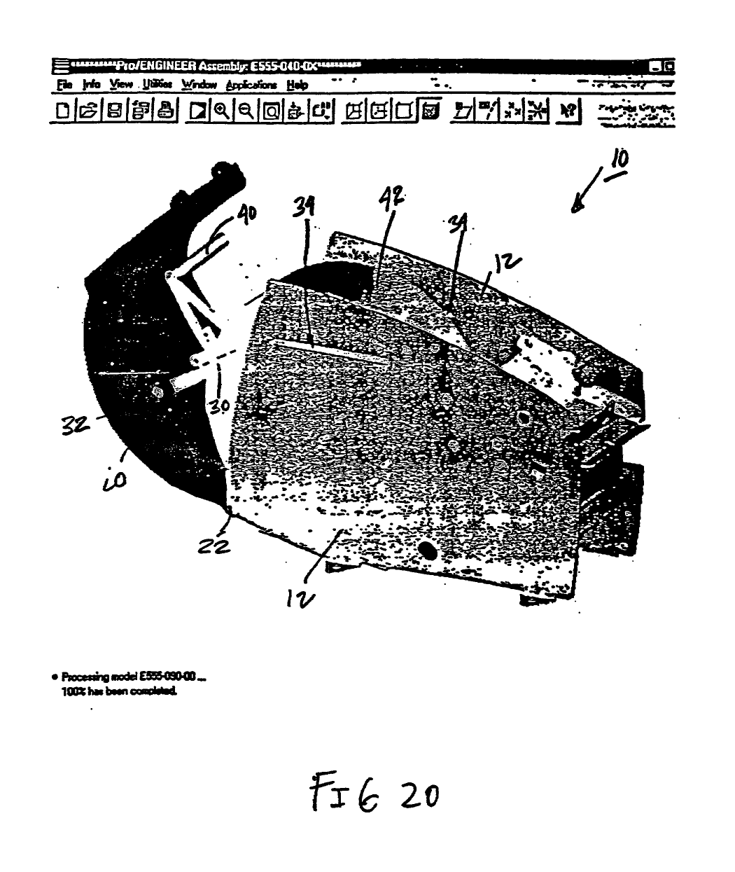

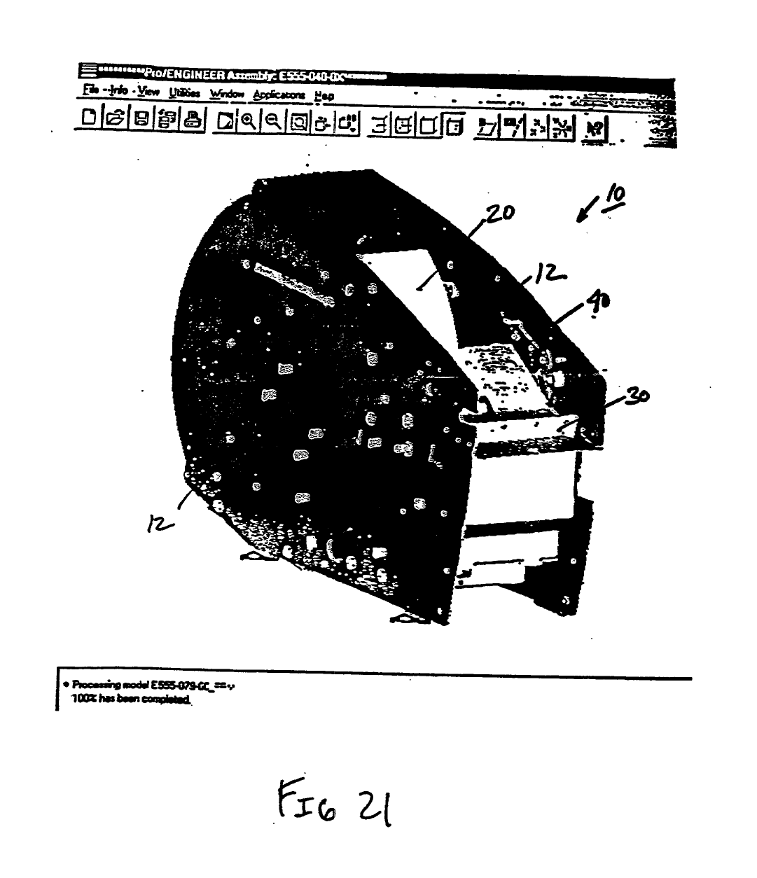

FIG. 16 shows the lever 240 operated into its upward position which has raised the cutting blade 200. The tape path is shown from the tape roll over the retractable guide roller (not shown), onto the tape tray, under the drive wheel, and through the cutting blade aperture.

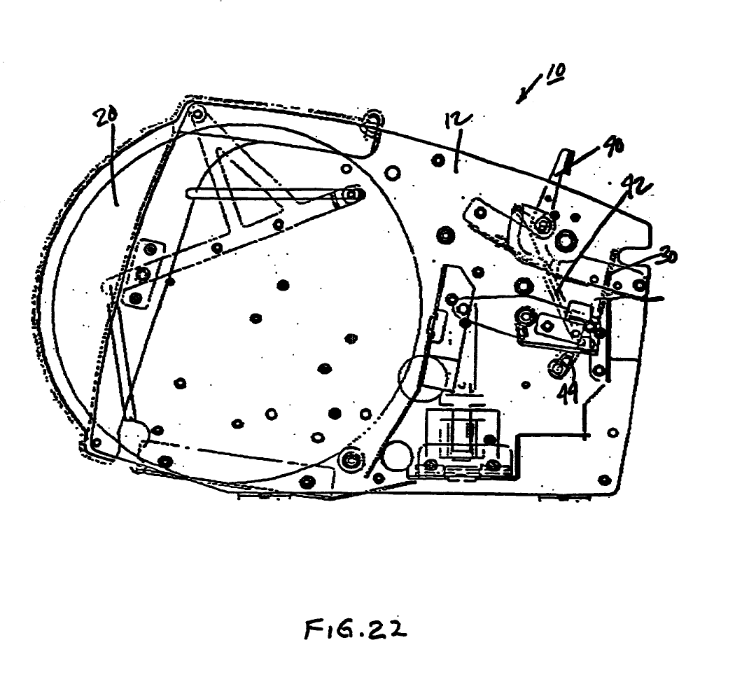

FIG. 17 shows a lower view of the assembly with the cutting blade in a raised position. It should be understood that the top cover cannot be lowered into an operating position with the lever 240 in its raised position. Therefore the magnetic interlock is open because the top cover is raised and the tape dispenser will not operate in this configuration.

FIG. 18 shows the return spring 212 which powers the cutting blade in a downward movement after the solenoid 202 relaxes.

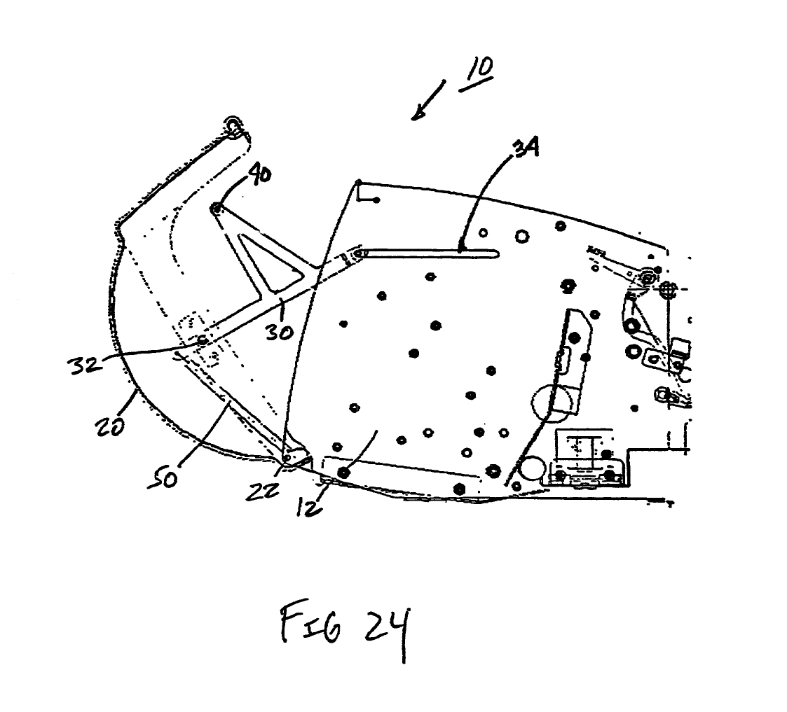

FIG. 19 shows the lever 240 in a raised position with the cam lobes 244 rising up against the actuator arm 206.

In the embodiments of the present invention described above, it will be recognized that individual elements and/or features thereof arc not necessarily limited to a particular embodiment but, where applicable, are interchangeable and can be used in any selected embodiment even though such may not be specifically shown. Terms such as “upper”, “lower”, “inner”, “outer”, “inwardly”, “outwardly”, and the like, when used herein, refer to the positions of the respective elements shown on the accompanying drawing figures and the present invention is not necessarily limited to such positions. It will thus be seen that the objects set forth above, among those elucidated in, or made apparent from, the preceding description, are efficiently attained and, since certain changes may be made in the above construction and/or method without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention which, as a matter of language, might be said-to fall therebetween.

We claim:

1. A sealing tape dispenser, comprising:
a housing having a removable cover;
a guide roller for guiding tape;
wherein said guide roller is movable between an operable position and a tape loading position.

2. A sealing tape dispenser for dispensing material comprising:
a cutting blade for cutting said dispensed material;
a mechanical linkage connected to said cutting blade and movable between an operable position and an inoperable position;
whereby an operator may clear material jams when said cutting blade is in said inoperable position.
